(19) United States
(12) Patent Application Publication
(10) Pub. No.: US 2020/0195102 A1
(43) Pub. Date: Jun. 18, 2020

(54) METHOD AND DEVICE FOR HOLDING A LAMINATED CORE IN POSITION TOGETHER WITH CONDUCTOR ELEMENTS RECEIVED THEREIN

(71) Applicant: Miba Automation Systems Ges.m.b.H., Laarkirchen (AT)

(72) Inventors: Andreas Falkner, Wels (AT); Mladen-Mateo Primorac, St. Pölten (AT); David Scherrer, Gmunden (AT)

(21) Appl. No.: 16/643,510

(22) PCT Filed: Aug. 9, 2018
(86) PCT No.: PCT/AT2018/060185

§ 371 Date: Feb. 28, 2020

(30) Foreign Application Priority Data
Sep. 1, 2017 (AT) A50737/2017

(51) Int. Cl. H02K 15/00

(52) U.S. Cl. CPC H02K 15/0087

(57) ABSTRACT

The invention relates to a method as well as a device (16) for the positioned holding of a laminated core (2) including at least one layer (9, 10) accommodated in the laminated core (2), which layer is made up of several conductor elements (3, 4) arranged spread over the circumference of the laminated core (2) and configured as rods for forming a stator or a rotor of an electric machine. The first front face (7) of the laminated core (2) comes into flush contact with first stop faces (21) of first support elements (20) and the first support elements (20) are readjusted into open spaces between the conductor elements (3, 4). The second stop faces (23) of second support elements (22) then come into flush contact with a second front face (8) of the laminated core (2) and the second support elements (22) are also readjusted into the open spaces between the conductor elements (3, 4). This allows for the laminated core (2) to be held in a positioned manner.

The invention relates to a method as well as a device for the positioned holding of a laminated core including at least one layer accommodated in the laminated core, which layer is made up of several conductor elements arranged spread over the circumference of the laminated core and configured as rods for forming a stator or a rotor of an electric machine.

U.S. Pat. No. 2,270,472 A describes a plant for producing a part of an electric machine, in particular of a rotor, in which the conductor elements are formed by so-called hairpins. Those free end portions which are later to be interconnected for forming an electric winding are to be deformed in oppositely-aligned circumferential directions before their connection process. In order to avoid damage to the insulation of the conductor elements as well as to a separate insulation layer of the laminated core during this deforming process, ends are readjusted by support fingers respectively into the open spaces located between the conductor elements. Here, the support fingers come into flush contact with the front face formed by the laminated core. During the mutual deforming process of the end portions of the conductor elements, the individual support fingers serve as a bending underlay for the conductor elements.

It was the object of the present invention to provide a method and a device by means of which a user is able to achieve a fixed-position as well as bilateral holding of the laminated core including the conductor elements accommodated therein.

This object is achieved by a method and a device as described in the claims.

The method of the invention serves the positioned holding of a laminated core including at least one layer accommodated in the laminated core, which layer is made up of several conductor elements arranged spread over the circumference of the laminated core and configured as rods for forming a stator or a rotor of an electric machine and comprises the following steps:
provisioning of the laminated core made up of several sheet metal segments resting directly against each other and defining a longitudinal axis, wherein several receiving groove arranged spread over the circumference are arranged in the laminated core and the receiving grooves extend respectively between a first front face and a second front face, wherein the receiving grooves serve to accommodate circuit sections of an electric winding,
provisioning of the rod-shaped conductor elements respectively having a first end portion and respectively having a second end portion spaced apart therefrom, wherein the conductor elements serve to form the electric winding and the conductor elements are configured with a rod length which is larger than a thickness of the laminated core between its first front face and its second front face,
inserting of at least one of the conductor elements in several of the receiving grooves,
positioned aligning of the conductor elements in an axial direction with respect to at least one of the two front faces of the laminated core, wherein the first end portions of the conductor elements protrude respectively beyond the first front face and the second end portions protrude respectively beyond the second front face, and wherein
a plurality of first support elements arranged spread over the circumference and configured in a rod shape with its first ends facing the longitudinal axis are readjusted from a position not overlapping an outer circumference of the laminated core in a direction toward the longitudinal axis to a position overlapping section by section the first front face in a direction toward the longitudinal axis to such an extent so that the first ends are located on the side facing away from the longitudinal axis as well as just outside of the conductor elements accommodated in the receiving grooves and the first support elements at their sides respectively facing the laminated core form a first stop face aligned in a vertical direction,
the laminated core including the conductor elements aligned in a positioned manner with the longitudinal axis having a horizontal alignment comes with its first front face into flush contact in an axial direction with the first stop faces of the first support elements,
a plurality of second support elements arranged spread over the circumference and configured in a rod shape with their second ends facing the longitudinal axis are readjusted from a position not overlapping an outer circumference of the laminated core in a direction toward the longitudinal axis to a position overlapping section by section the second front face in a direction toward the longitudinal axis to such an extent so that the second ends are located on the side facing away from the longitudinal axis as well as just outside of the conductor elements accommodated in the receiving grooves and the second support elements at their sides respectively facing the laminated core form a second stop face aligned in a vertical direction,
the second support elements with their second stop faces in an axial direction with respect to the longitudinal axis are readjusted in a direction toward the laminated core until a majority of the second stop faces are in flush contact with the second front face,
that the first support elements are readjusted further in a direction toward the longitudinal axis, wherein preferably at least one of the first support elements is readjusted into each open space located between the conductor elements in a circumferential direction, and
the second support elements are also readjusted further in a direction toward the longitudinal axis, wherein preferably at least one of the second support elements is readjusted into each open space located between the conductor elements in a circumferential direction.

It is advantageous in the process steps selected here that this allows a positioned alignment of the laminated core including the conductor elements accommodated therein by means of the first support elements being done first because the flush contact of the first front face with the circumferentially-arranged first stop faces having been made in an axial direction as well as in a preferably horizontal alignment already allows to achieve a predetermined positioning. By further advancing the second support elements and bringing them into flush contact also in an axial direction with respect to the longitudinal axis of the laminated core, this allows to achieve a sufficient further position fixing of the overall laminated core including the conductor elements. Once both the first support elements and the second support elements have respectively been readjusted into the open spaces located between the conductor elements, this allows to achieve sufficient position fixing of the conductor elements as well as of the laminated core. This allows to achieve, by means of the process steps, a secure position fixing of the laminated core within the device, if required while using the device for the positioned holding of the laminated core, without further device elements.

Furthermore, a practice is advantageous in which the first support elements and/or the second support elements are readjusted into the open spaces respectively located between the conductor elements in a circumferential direction to such an extent that the open spaces between the individual conductor elements are fully or at least almost fully filled out. This allows to achieve nearly up to full clamping of the conductor elements arranged behind each other in a circumferential direction by the support elements arranged respectively between these. Furthermore, however, this also allows for the laminated core to be cosupported by the support elements, which support elements are in flush contact with the conductor elements.

Another advantageous practice is characterized in that the readjustment of the first support elements and of the second support elements is carried out respectively in a radial direction. This allows a collision-free readjustment movement of the support elements into the open spaces located respectively between the conductor elements to be carried out in a secure and collision-free manner.

Also advantageous is a variant of the method in which the laminated core including the conductor elements aligned in a positioned manner is accommodated by a holding arm of a holding device before its first front face comes into flush contact with the first stop faces of the first support elements, wherein holding elements located at the holding arm and readjustable in a radial direction are pushed against an inner surface of the laminated core. This allows for a central holding and for subsequent handling processes of the laminated core including the conductor elements to be carried out in a secure and accurate manner.

Another practice is characterized in that the end portions of the conductor elements of the at least one layer, which conductor elements are aligned in a positioned manner and which end portions protrude beyond the laminated core, are subjected respectively to a pressure built up by at least one pressure element of a pressure device, which pressure element is readjustable in a radial direction, and are thus held in a direction of the longitudinal extent of the receiving grooves which is positioned relative with respect to the laminated core. This allows to reliably prevent a relative shifting of the conductor elements already accommodated in the receiving grooves with respect to the laminated core during the handling processes to be carried out. This is particularly when, starting from a position of the longitudinal axis of the laminated core having a vertical alignment, the longitudinal axis of the laminated core is to be pivoted to a horizontal position.

Furthermore, a practice is advantageous in which the laminated core including the conductor elements aligned in a positioned manner is aligned in a positioned manner in a circumferential direction with respect to a target position before its first front face comes into flush contact with the first stop faces of the first support elements. This allows for each laminated core as well as the conductor elements already accommodated therein to be accommodated in the device in a mutually identical positioned alignment and this unit can thus be transported or conveyed onward to a downstream processing station, such as a deforming station for the end portions of the conductor elements, after the holding and clamping process has been completed.

Another advantageous practice is characterized in that the laminated core including the conductor elements aligned in a positioned manner is pivoted from a position of the longitudinal axis having a vertical alignment to the position of the longitudinal axis having a horizontal alignment before its first front face comes into flush contact with the first stop faces of the first support elements. This allows for a gravity-supported positioning of the individual conductor elements within the laminated core to be done, preferably in an automatic manner. This also allows to prevent a rolling away of the laminated core during its transport movement between the individual work stations.

Also advantageous is a variant of the method in which the first support elements are arranged or configured respectively at least in pairs at a first slider element and the second support elements are arranged or configured respectively at least in pairs at a second slider element. This allows to reduce the number of the readjustment mechanisms for the support elements.

Another practice is characterized in that a first retaining projection is arranged or configured respectively at the first support elements, in particular at the first slider elements, and a second retaining projection is arranged or configured respectively at the respective second support elements, in particular at the second slider elements. This creates the possibility to also be able to exert an additional and direct clamping effect starting from the support elements or the sliding elements on the laminated core. The retaining projections are arranged or configured in such a way that they come into flush contact with the outer circumference and/or with the outer circumferential surface of the laminated core in this process.

Furthermore, a practice is advantageous in which, after the first front face of the laminated core has come into flush contact with and is supported by the first stop faces of the first support elements and with the first support elements respectively being in the position in a circumferential direction in the open spaces between the conductor elements, the laminated core including the conductor elements is held clamped by the first support elements and/or the first retaining projections. Depending on the dimensional design of the support elements as well as the radial arrangement of the retaining projections, this allows for the clamping effect at the laminated core and/or the conductor elements to be determined accurately in advance.

Another advantageous practice is characterized in that, after the second stop faces of the second support elements have come into axial flush contact and are supported by the second front face of the laminated core and before the further radial readjustment movement of the second support elements into the respective open spaces located between the conductor elements or after this readjustment movement, the holding elements pushed against the inner surface of the laminated core are readjusted away from the inner surface and the holding arm of the holding device is readjusted in an axial direction out of the interior of the laminated core. Depending on the time scale of the clamp and release movements, a secure and collision-free readjustment of the individual support elements into the respective open spaces between the conductor elements can thus be ensured also in the area of the second holding unit with the second support elements.

Also advantageous is a variant of the method in which, after the second stop faces of the second support elements have come into flush contact with and are supported by the second front face of the laminated core and with the second support elements respectively being in the position in a circumferential direction in the open spaces between the conductor elements, the laminated core including the conductor elements is held clamped by the second support elements and/or the second retaining projections. This allows to achieve a secure and bilateral positioned holding and clamping of the laminated core and/or the conductor elements.

Another practice is characterized in that the first support elements, in particular the first slider elements, are readjusted by a first drive device, in particular a cylinder-piston configuration, a servo drive, in a radial direction and the second support elements, in particular the second slider elements, are readjusted by a second drive device, in particular a cylinder-piston configuration, a servo drive, are readjusted also in a radial direction. Depending on the selected drive medium, this allows for the propulsion force respectively required for the individual readjustment movements to be accurately predetermined and applied.

Another advantageous practice is characterized in that the first support elements, in particular the first slider elements, are arranged positioned in place in an axial direction and the first stop faces form a reference plane having a vertical alignment. This allows to create an accurate plane of reference by the first stop faces of the first support elements for the first front face of the laminated core which is to come into flush contact with it.

Also particularly advantageous is a variant of the method in which at least the second support elements, in particular at least the second slider elements, are readjustable in an axial direction with respect to the first support elements, in particular with respect to the first slider elements. This is a simple manner to allow for tolerance-related deviations in the thickness of the laminated core through adequate readjustment processes. Furthermore, this allows a positioned holding in the device also of laminated cores with other dimensions.

Another practice is characterized in that at least the second support elements, in particular the second slider elements, are readjusted together in an axial direction by a third drive device, in particular a cylinder-piston configuration, a servo drive. This allows to exert a contact pressure of the second holding unit with the second support elements on the laminated core, which contact pressure is predetermined in an axial direction, and thus also to additionally build up a clamping force acting in an axial direction.

Another practice is characterized in that the laminated core positioned in an axial direction between the first support elements and the second support elements is pushed against the first support elements by the second support elements in an axial direction. The circumferential pushing of the support elements against the laminated core allows for the latter to be already held aligned in a secure, exact position by the bilaterally-arranged support elements.

When an axial distance in a normal direction is acquired between the first and second stop faces, with a laminated core positioned between the first support elements and the second support elements and with first stop faces in flush contact with the first front face and the second stop face in flush contact with the second front face of the laminated core, the exact thickness in an axial direction of the laminated core can thus be acquired by means of a measuring means allocated to the support elements or at least one of the holding units or a measuring arrangement. Due to minimal variations in sheet thickness, the arrangement of multiple individual sheet metal segments on top of each other can cause variations in the overall thickness or overall strength of the laminated core. This allows for the exact thickness and/or strength of each individual laminated core to be acquired every time without additional work steps.

Furthermore, a practice is advantageous in which the laminated core aligned in a positioned manner by the first and second support elements is transported at least including the support elements to a downstream deforming station for respectively deforming the end portions of the conductor elements protruding beyond the two front faces. This creates the possibility to be able to divide individual work steps between several processing stations in order to thus achieve a high productivity of the overall plant. This is because running processing and/or deforming processes can be carried out simultaneously with each other.

The device of the invention serves the positioned holding of a laminated core including at least one layer accommodated in the laminated core, which layer is made up of several conductor elements arranged spread over the circumference of the laminated core and configured as rods for forming a stator or a rotor of an electric machine, the device comprises:
a first holding unit with a plurality of first support elements arranged spread over the circumference, wherein a first stop face aligned in a vertical direction is formed respectively by the first support elements at their sides which are turnable toward the laminated core and the first support elements are readjustably guided in a radial direction at the first holding unit,
a second holding unit with a plurality of second support elements arranged spread over the circumference and configured in a rod shape, wherein a second stop face aligned in a vertical direction is formed respectively by the second support elements at their sides which are turnable toward the laminated core and the second support elements are readjustably guided in a radial direction at the second holding unit, and
at least one of the two holding units is readjustably guided at a base frame relative with respect to the other holding unit in a normal direction with respect to the stop faces.

The advantage thereby achieved is that this allows for a positioned alignment of the laminated core including the conductor elements accommodated therein by means of the first support elements to be done first because the coming into flush contact of the first front face with the circumferentially-arranged first stop faces which was done in an axial direction as well as in a preferably horizontal alignment already allows to achieve a predetermined positioning. By further advancing the second support elements and bringing them into flush contact also in an axial direction with respect to the longitudinal axis of the laminated core, this already allows to achieve a sufficient further position fixing of the overall laminated core including the conductor elements. Once both the first support elements and the second support elements have been readjusted respectively into the open spaces located between the conductor elements, this allows to achieve sufficient position fixing of the conductor elements as well as of the laminated core. This allows to achieve, by means of the process steps, a secure position fixing of the laminated core within the device, if required while using the device for the positioned holding of the laminated core, without further device elements.

Furthermore, it can be advantageous if the first support elements are arranged or configured respectively at least in pairs at a first slider element and the second support elements are arranged or configured respectively at least in respective pairs at a second slider element and the first slider elements are guided at the first holding unit and the second slider elements are guided at the second holding unit. This allows to reduce the number of the readjustment mechanisms for the support elements.

Another embodiment is characterized in that a first retaining projection is arranged or configured respectively at the first support elements, in particular at the first slider elements, and a second retaining projection is arranged or configured respectively at the second support elements, in particular at the second slider elements, and the first retaining projections and the second retaining projections are arranged at sides of the support elements, in particular of the slider elements, respectively facing each other. This creates the possibility to also be able to exert an additional and direct clamping effect originating from the support elements or the sliding elements on the laminated core. The retaining projections are arranged or configured in such a way that they come into flush contact with the outer circumference and/or with the outer circumferential surface of the laminated core in this process.

The features of another possible embodiment are that the first support elements, in particular the first slider elements, are in drive connection with a first drive device, in particular a cylinder-piston configuration, a servo drive, and the second support elements, in particular the second slider elements, are in drive connection with a second drive device, in particular a cylinder-piston configuration, a servo drive, and the drive devices can carry out the readjustment movements in a radial direction. Depending on the selected drive medium, this allows for the propulsion force respectively required for the individual readjustment movements to be accurately predetermined and applied.

Another formation provides that the first holding unit is arranged positioned in place at the base frame and a reference plane with a vertical alignment is formed by the first stop faces of the first support elements. This allows to create an exact plane of reference by the first stop faces of the first support elements for the first front face of the laminated core to come into flush contact with it.

Another embodiment is characterized in that at least the second holding unit is readjustably guided at the base frame in an axial direction with respect to the first holding unit and the second holding unit is in drive connection with a third drive device, in particular a cylinder-piston configuration, a servo drive. This allows to exert a contact pressure of the second holding unit with the second support elements on the laminated core, which contact pressure is predetermined in an axial direction, and thus also to additionally build up a clamping force acting in an axial direction.

For the purpose of a better understanding of the invention, the latter will be elucidated in more detail by means of the figures below.

In a strongly simplified, schematic depiction, each figure shows as follows:

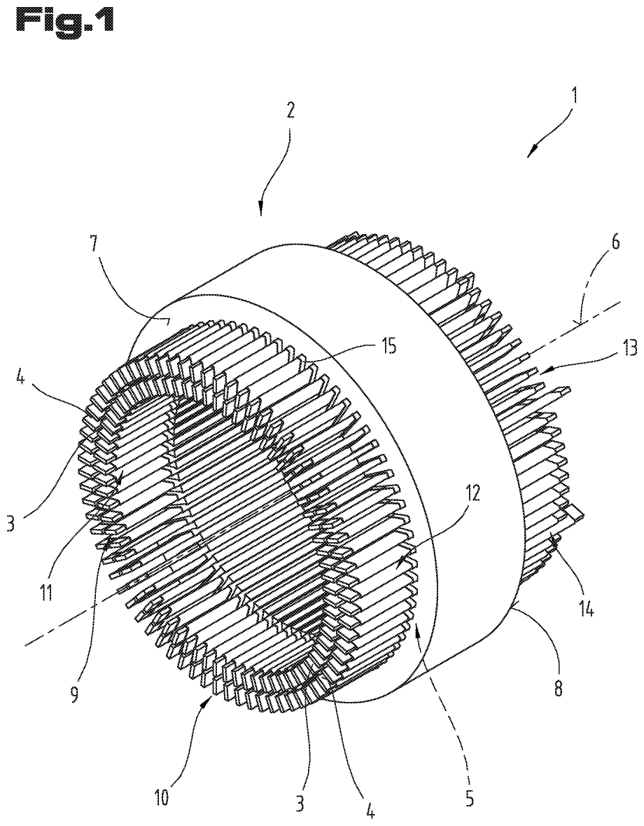

FIG. 1 a graphic depiction of a laminated core with a plurality of conductor elements accommodated therein;

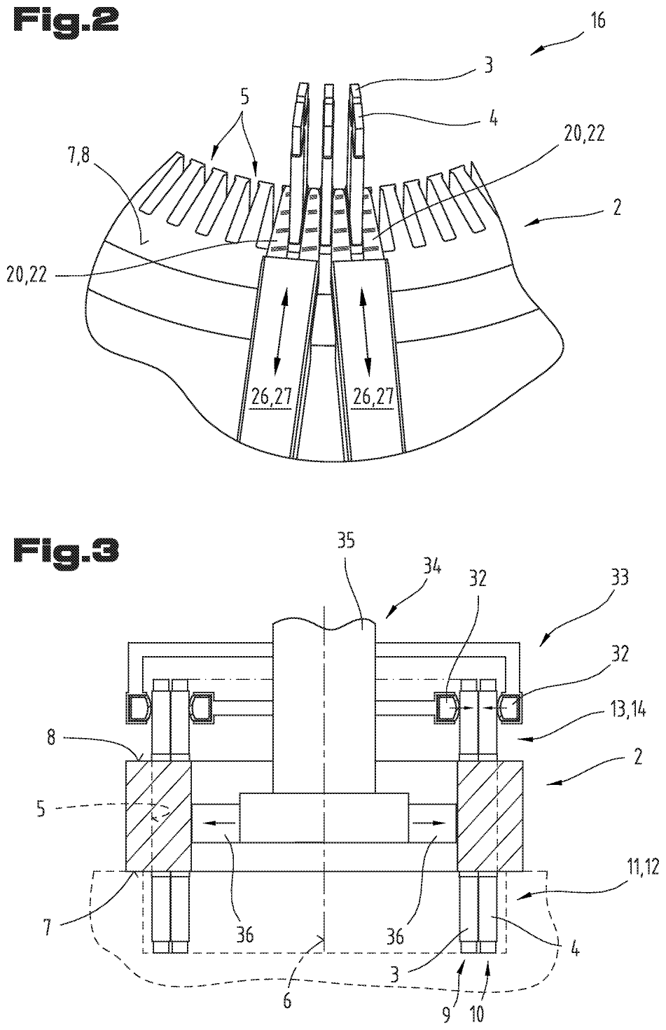

FIG. 2 a graphic depiction of a possible formation and arrangement of the support elements at a joint slider element, with a section of the laminated core as well as the conductor elements accommodated therein;

FIG. 3 a view and highly-stylized depiction of the laminated core including the conductor elements accommodated therein and a holding device holding the laminated core;

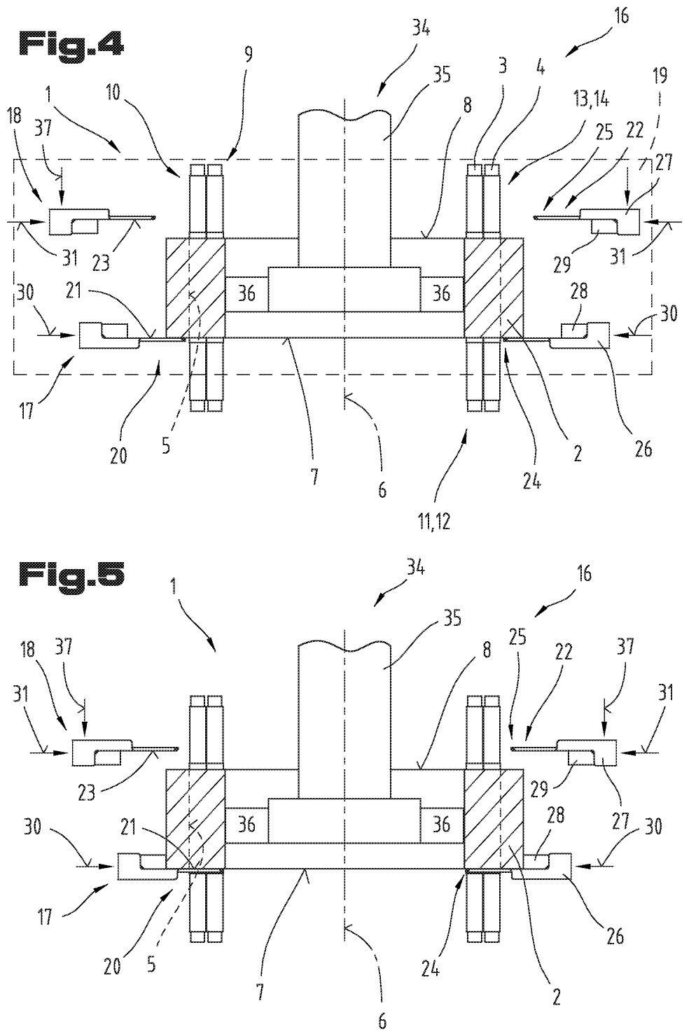

FIG. 4 a sectional plan view as well as highly-stylized depiction of a first step of the course of the procedure, in which the laminated core comes into flush contact with the first support elements;

FIG. 5 a sectional plan view as well as highly-stylized depiction of another step of the course of the procedure, in which the first and second support elements have respectively been readjusted in a radial direction toward the longitudinal axis of the laminated core;

FIG. 6 a sectional plan view as well as highly-stylized depiction of another step of the course of the procedure, in which the second support elements have come into flush contact with the second front face of the laminated core;

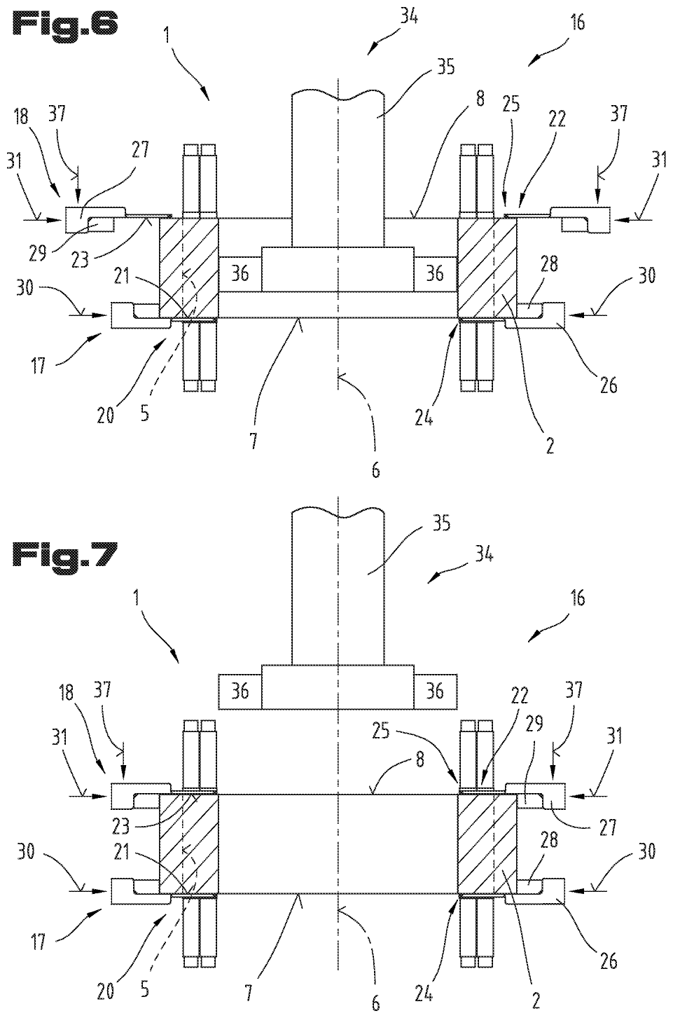

FIG. 7 a sectional plan view as well as highly-stylized depiction of another step of the course of the procedure, in which the respective second support elements have been readjusted in a radial direction toward the longitudinal axis of the laminated core and the holding device has been readjusted out of the laminated core;

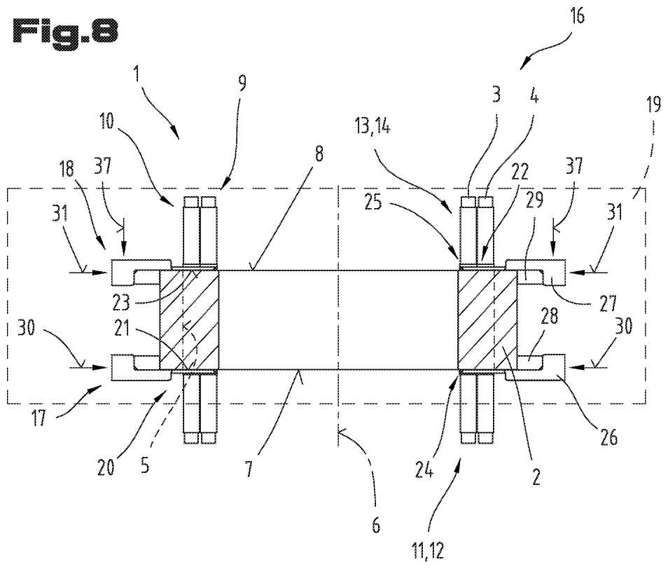

FIG. 8 a sectional plan view as well as highly-stylized depiction of another step of the course of the procedure, in which the second contact surfaces of the second support elements have been pushed forcefully against the second front face of the laminated core.

First of all, it is to be noted that, in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, and these specifications of location are to be analogously transferred to the new position.

The term “in particular” shall henceforth be understood to mean that it may refer to a possible more specific formation or more detailed specification of an object or a process step, but need not necessarily depict a mandatory, preferred embodiment of same or a mandatory practice.

FIG. 1 shows a possible formation of a stator 1 for forming an electric machine not depicted in more detail. However, it would also be possible to analogously apply and carry out the description and embodiment below also to a rotor for forming an electric machine. The description below refers only to a stator 1, but it may equally relate to a rotor.

The assembly and a plurality of manufacturing steps of the stator 1 can be carried out in an automated manner, largely even in a fully-automated manner, in several manufacturing stations, preferably in a complex manufacturing plant.

In principle, the stator 1 comprises a laminated core 2 as well as a plurality of conductor elements 3, 4 to be accommodated therein for creating a rotating magnetic field by means of coils.

In the present exemplary embodiment the individual conductor elements 3, 4 are configured in the latter's non-deformed initial situation as straight rods. The rods typically have a rectangular cross-section up to a square cross-section as well as a longitudinal extent and are formed by an electrically-conductive material. This material is usually a copper material. Therefore, these can also be referred to as profile rods. In a known manner, the conductor elements 3, 4, with the exception of contact areas formed at them can be surrounded by an insulation layer not depicted or designated in more detail.

A plurality of receiving grooves 5 are arranged or configured in the laminated core 2 spread over the circumference for forming electric coils and windings formed thereby, in which receiving grooves 5 at least one of the conductor elements 3, 4, but preferably at least two of the conductor elements 3, 4, is or are respectively accommodated or arranged. The receiving grooves 5 can extend in an axial direction as well as preferably in a parallel alignment with respect to a longitudinal axis 6 defined by the laminated core 2. However, it would also be possible to select non-parallel alignment of the receiving grooves 5 with the conductor elements 3, 4 to be accommodated therein. In this way, the receiving grooves 5 respectively extend in a direction of the longitudinal axis 6 between a first front face 7 and a second front face 8 arranged spaced apart therefrom.

The receiving grooves 5 respectively have a cross-section of the receiving groove adapted to the cross-sectional dimension of the conductor element 3, 4 or in case of several conductor elements 3, 4 accommodated in the same receiving groove 5 a cross-section of the receiving groove adapted to the cross-sectional dimensions to same.

The laminated core 2 is a pack composed of a plurality of individual metal sheets or sheet metal segments electrically insulated from each other and is limited in a direction of the longitudinal axis 6 by the first front face 7 and the second front face 8 arranged spaced apart from same. Preferably, the two front faces 7, 8 are arranged in parallel to one another as well as running in a plane aligned in a normal direction with respect to the longitudinal axis 6. In the present exemplary embodiment the pack of the individual metal sheets or the sheet metal segments forms a hollow cylinder having an inner surface and an outer surface.

Preferably, at least one of the conductor elements 3, 4, but preferably several, in particular two, three, four, five, six or even more conductor elements 3, 4, is arranged in each of the receiving grooves 5. Even eight, ten, twelve or more of the conductor elements 3, 4 may be accommodated. As a minimum variant, one conductor element 3, 4 is provided, whereas in this exemplary embodiment two conductor elements 3, 4 are depicted and described in one respective receiving groove 5. In this way, the conductor elements 3 arranged in a radial direction on the inside form a first layer 9 and the conductor elements 4 arranged in a radial direction on the outside form a second layer 10.

Each of the conductor elements 3 and 4 comprises respectively at its first end a first end portion 11, 12 and comprises respectively at its opposite second end a second end portion 13, 14. In this exemplary embodiment the first end portions 11, 12 protrude beyond the first front face 7 and the second end portions 13, 14 protrude beyond the second front face 8 of the laminated core 2.

The conductor elements 3, 4 accommodated in the individual receiving grooves 5 in the laminated core 2 and usually as yet non-deformed are twisted against or crossed over each other in a known manner in a circumferential direction in the area of the end portions 11, 12; 13, 14 of each of the front faces 7, 8 in one of the downstream manufacturing steps, in order to subsequently thus connect in an electrically-conductive manner a first of the end portions 11 of the first or inner layer 9 to another, corresponding first end portion 11 of the second or outer layer 10. The same can preferably be carried out also with the respective second end portions 13, 14 in the area of the second front face 8.

Furthermore, it may also be advantageous if the individual conductor elements 3, 4, in addition to their insulation layer within the receiving grooves 5, are also surrounded by a separate insulation element 15, preferably along the entire circumference.

The feeding or the inserting of the individual conductor elements 3, 4 in(to) the respective receiving grooves 5 may be done step by step or cycle by cycle, wherein the longitudinal axis 6 of the laminated core 2 in this process is in a horizontal alignment. As the usually non-deformed conductor elements 3, 4 are accommodated longitudinally slidable in the respective receiving grooves 5, the relative position of the conductor elements 3, 4 with respect to the laminated core 2 is to be taken into consideration or ensured during the transfer to a downstream processing station or manufacturing station.

In a positioning step to be carried out preferably before the transfer or passing on to the downstream processing station or manufacturing station, the conductor elements 3, 4 can be aligned in an axial direction with respect to one of the front faces 7, 8. This can be done, for example, by moving the laminated core 2 including the conductor elements already accommodated therein 3, 4 from its preferably horizontal feed position to a vertical positioning position, in which the longitudinal axis 6 of the laminated core 2 has a vertical longitudinal alignment. The laminated core 2 can use a positioning projection for support, wherein the conductor elements 3, 4 in a preferably gravity-induced manner come into flush contact within the individual receiving grooves 5 with one of their end portions 11, 12 or 13, 14 up to a positioning element preferably formed circumferentially. The distance between the positioning projection and the positioning element is to be selected in accordance with the given protrusion of the ends of the conductor elements 3, 4 beyond one of the front faces 7, 8 of the laminated core 2. This transport position may, for example, be taken on a work carrier movable between individual of the work stations.

The active or passive transfer to a downstream processing station or manufacturing station is now to be carried out in this position of the longitudinal axis 6 having a vertical alignment without changing the relative position of the already prepositioned conductor elements 3, 4 with respect to the laminated core 2.

To that end, at least the process steps specified below for the positioned holding of the laminated core 2 including at least one layer 9, 10 accommodated in the laminated core 2, which layer is made up of several conductor elements 3, 4 arranged spread over the circumference of the laminated core 2 and configured as rods for forming a stator 1 or a rotor of an electric machine can be carried out, if required while using a device, wherein this is depicted in FIGS. 2 to 8:

The laminated core 2 made up of several sheet metal segments resting directly against each other and defining a longitudinal axis 6 having several receiving grooves 5 arranged spread over the circumference is provisioned. Furthermore, the rod-shaped conductor elements 3, 4 respectively having a first end portion 11, 12 and respectively having a second end portion 13, 14 arranged spaced apart therefrom are to be provisioned. As a next step, the inserting and/or introducing of at least one of the conductor elements 3, 4 in(to) preferably each of the receiving grooves 5 can be carried out. Here, it is not necessarily mandatorily required to actually place at least one of the conductor elements 3, 4 into each of the receiving grooves 5. For example, it may well be that, while at least one of the conductor elements 3, 4 is indeed placed into a majority of the receiving grooves 5, none of the conductor elements 3, 4 is placed into individual of the plurality of the receiving grooves 5. This is why several of the receiving grooves 5 are assumed, which are configured for accommodation of the at least one conductor element 3, 4.

Once this has been done, the conductor elements 3, 4 are to be aligned positioned in an axial direction with respect to at least one of the two front faces 7, 8 of the laminated core 2, wherein the first end portions 11, 12 of the conductor elements 3, 4 protrude beyond the respective first front face 7 and the second end portions 13, 14 protrude beyond the respective second front face 8.

A device 16, which can also be used as part of a manufacturing plant not depicted in more detail for producing and joining in an automated manner components of an electric machine, serves the positioned holding of the laminated core 2 including the conductor elements accommodated therein 3, 4.

The device 16 comprises at least a first holding unit 17 and a second holding unit 18, wherein at least one of the two holding units 17, 18 can be readjustably guided at a base frame 19. The first holding unit 17 itself comprises a plurality of first support elements 20 arranged spread over the circumference of the laminated core 2 to be held, and configured in a rod shape or pin shape. These support elements 20 at their sides respectively facing the laminated core 2 form a first stop face 21 aligned in a vertical direction. Furthermore, the first support elements 20 are readjustably guided in a radial direction at the first holding unit 17.

The second holding unit 18 also comprises a plurality of second support elements 22 arranged spread over the circumference of the laminated core 2 to be held, and configured in a rod shape or pin shape. These form at their sides respectively facing the laminated core 2 a second stop face 23 aligned in a vertical direction. Furthermore, the second support elements 22 are readjustably guided at the second holding unit 18.

In the present exemplary embodiment it is provided that the first holding unit 17 is arranged positioned in place at the base frame 19 and a reference plane with a vertical alignment is formed by the first stop faces 21 of the first support elements 20. However, it would also be possible to provide a relative axial readjustment movement with respect to the base frame 19. In order to be able to carry out a relative readjustment movement of the second holding unit 18 in an axial direction with respect to the first holding unit 17, the second holding unit 18 is here readjustably guided at the base frame 19. This allows for also the second support elements 22 to be readjusted or dislocated in a relative axial direction with respect to the first support elements 20.

The readjustment of the first support elements 20 and of the second support elements 22 is preferably carried out respectively in a radial direction at the holding units 17, 18. In the holding state of the laminated core 2 the first support elements 20 respectively have first ends 24 facing the longitudinal axis 6. Similarly, also the second support elements 22 respectively have second ends 24 facing the longitudinal axis 6 in the holding state of the laminated core 2.

As can now be gleaned more readily from FIG. 2, the first support elements 20 can be arranged or configured respectively at least in pairs at a joint first slider element 26. As preferably the second support elements 22 are configured analogously to the first support elements 20, also the second support elements 22 can be arranged or configured respectively at least in pairs at a joint second slider element 27. At least is understood to mean here that also more than two support elements 20 or 22 can be arranged or configured respectively at one of the slider elements 26 or 27. For example, three, four or five pieces of support elements 20 or 22 could be provided at one of the slider elements 26 or 27. Although the support elements 20 or 22 are provided here respectively in pairs at a joint slider element 26 or 27, one of the finger-like support elements 20 or 22 is preferably readjusted respectively into each of the open spaces between the conductor elements 3, 4.

In this case, the first slider elements 26 are then guided and readjustable in a radial direction at the first holding unit 17 and the second slider elements 27 are guided and readjustable in a radial direction at the second holding unit 18. In order to be able to readjust the support elements 20, 22 respectively into the open spaces or gaps located in a circumferential direction between the receiving grooves 5, and therefore also between the conductor elements 3, 4, and preferably also achieve a support or flush contact of the longitudinal side surfaces of the support elements 20, 22, the surface shape of the support elements 20, 22 is to be adjusted to that of the open spaces or gaps. In the present exemplary embodiment the support elements 20, 22 have a wedge shape which tapers off respectively in a direction toward their end 24, 25.

In order to enable a possible additional clamping of the laminated core 2 by the first support elements 20 and/or the second support elements 22, a first retaining projection 28 can be arranged or configured respectively at the first support elements 20, in particular at the first slider elements 26, and/or a second retaining projection 29 can be arranged or configured respectively at the second support elements 22, in particular at the second slider elements 27. Here, the arrangement of the first and second retaining projections 28, 29 is done in such a way that they respectively face the laminated core 2. This allows for the first retaining projections 28 and the second retaining projections 29 to be arranged at sides of the support elements 20, 22, in particular of the slider elements 26, 27, respectively facing each other.

For the relative readjustment of the position of the first support elements 20, in particular of the first slider elements 26, a first drive device 30, in particular a cylinder-piston configuration, a servo drive or suchlike, is provided. Also the position of the second support elements 22, in particular of the second slider elements 27, can be readjusted by means of a separate second drive device 31, in particular with a cylinder-piston configuration, a servo drive or suchlike. For the sake of simplicity the two drive devices 30, 31 have been merely suggested by means of arrows. A corresponding drive connection is to be provided in this case. For example, an adjusting disc with guide lanes or guide extensions can be provided respectively in a known manner, which is in drive connection with one of the drive devices 30, 31, and furthermore the support elements 20, 22, in particular the slider elements 26, 27, can be in operative connection with the guide lane(s) or guide extension(s).

In order to be able to carry out the axial readjustment movement of the second holding unit 17 including the second support elements 22 as described above, a third drive device 37, in particular a cylinder-piston configuration, a servo drive or suchlike, can be provided. Here, too, for the sake of simplicity and improved clarity the third drive device 37 is also merely suggested using arrows. This allows for the laminated core 2 located in an axial direction between the first support elements 20 and the second support elements 22 to be pushed by the second support elements 20 in an axial direction against the first support elements 22.

The laminated core 2 including the conductor elements accommodated therein 3, 4 can be transported, e.g. by means of a work carrier, between the individual work stations in the manufacturing plant before being inserted in the device 16. This work carrier, not designated in more detail, is suggested by dashed lines in FIG. 2. In order to achieve a gravity-induced, relative, positioned alignment of the conductor elements 3, 4 accommodated in the receiving grooves 5, one of the front faces 7, 8 of the laminated core 2 can be put down and supported by the work carrier. In this case its longitudinal axis 6 has a vertical alignment. In the device 16, however, a horizontal alignment of the longitudinal axis 6 of the laminated core 2 is provided. Therefore the laminated core 2 including the conductor elements 3, 4 is to be pivoted from the position of the longitudinal axis 6 having a vertical alignment to the position of the longitudinal axis 6 having a horizontal alignment.

In order to avoid an undesired relative readjustment of the conductor elements 3, 4 in the receiving grooves 5 during this pivoting process, the end portions 11, 12; 13, 14 of the conductor elements 3, 4 of the at least one layer 9, 10, which conductor elements 3, 4 are aligned in a positioned manner and which end portions 11, 12; 13, 14 protrude beyond the laminated core 2, can respectively be subjected to a pressure built up by at least one pressure element 32 of a pressure device 33, which pressure element 32 is readjustable in a radial direction. This makes it possible to be able to hold all conductor elements 3, 4 in a positioned manner in a direction of the longitudinal extension of the receiving grooves 5 relative with respect to the laminated core 2. This is depicted in a simplified manner in FIG. 3.

Furthermore, FIG. 3 also shows that for the pivoting process the laminated core 2 can be seized and held clamped by a holding device 34 by means of a holding arm 35 as well as holding elements 36 readjustable in a radial direction at the holding arm 35. Several holding elements 36 can be provided, which are arranged spread over the inner circumference of the laminated core 2 and are pushed against an inner surface of the laminated core 2 for holding. After seizing and holding the laminated core 2 including the conductor elements 3, 4 aligned in a positioned manner, the laminated core 2 can be aligned in a positioned manner in a circumferential direction with respect to a target position. For the inserting of the support elements 20, 22 and holding process by the support elements 20, 22, this is to enable a collision-free inserting of the support elements 20 in the open spaces located respectively between the conductor elements 3, 4. To that end, an alignment mark such as, for example, a notch or groove can be arranged or configured at the laminated core 2.

FIGS. 4 to 8 show a highly schematic depiction of the sequence for the positioned holding of the laminated core 2 in the device 16. It should be noted in this context that the chronology of the individual work steps is specified merely by way of example and also a sequence deviating therefrom can be carried out. This may in particular relate to the advance of the support elements 20, 22 in a radial direction and axial direction as well as the application of the radial clamping force of the retaining projections 28, 29 to the laminated core 2. Furthermore, the term “to be in flush contact” or “to come into flush contact” of the stop faces 21, 23 of the support elements 20, 22 with the respective front faces 7, 8 is understood to mean merely a pressureless, light support as opposed to a rigid and force-based clamping. Therefore, in this state it is not necessarily required that all of the support elements 20, 22 are in flush contact with the respective front face 7, 8, but preferably a majority of same. In any case, this is more than 50% of the overall number of support elements 20 or 22.

The first holding unit 17 with the first support elements 20 is arranged in the area of the first front face 7. The second holding unit 18 with its second support elements 22 is arranged in the area of the second front face 8 of the laminated core 2. As described above, the first support elements 20 at their sides respectively facing the laminated core 2 form the first stop faces 21 aligned in a vertical direction. The laminated core 2 including the conductor elements 3, 4 is moved toward the first stop faces 21 in a normal direction. In order to form a stop and/or a support surface, the first ends 24 of the first support elements 20 respectively facing the longitudinal axis 6 are to be readjusted from a position not overlapping an outer circumference of the laminated core 2 in a direction toward the longitudinal axis 6 to a position overlapping section by section the first front face 7 in a direction toward the longitudinal axis 6 to such an extent that the first ends 24 are located at the side of the conductor elements 3, 4 facing away from the longitudinal axis 6 as well as just outside of the conductor elements 3, 4 accommodated in the receiving grooves 5.

When the first support elements 20 are located in this position, the first front face 7 of the laminated core 2 including the conductor elements 3, 4 aligned in a positioned manner with the longitudinal axis 6 having a horizontal alignment can in an axial direction come into flush contact with and be supported by the first stop faces 21 of the first support elements 20. The first ends 24 of the first support elements 20 arranged and aligned radially with respect to a center delimit a circular shape viewed over the circumference, wherein also the longitudinal axis 6 of the laminated core 2 is to be arranged running in this center.

When the first front face 7 of the laminated core 2 is in flush contact with the first stop faces 21, the first support elements 20 can be readjusted further toward the direction of the longitudinal axis 6. Viewed in a circumferential direction an open space is formed between each receiving groove 5, and therefore also between the conductor elements 3, 4, into which open space at least one of the first support elements 20 is readjusted respectively.

Once this has been done, in the area of the second front face 8 the second ends 25 of the second support elements 22 of the second holding unit 18 facing the longitudinal axis 6 are also readjusted from a position not overlapping the outer circumference of the laminated core 2 in a direction toward the longitudinal axis 6 to a position overlapping section by section the second front face 8 in a direction toward the longitudinal axis 6 to such an extent that the second ends 25 are located at the side facing away from the longitudinal axis 6 as well as just outside of the conductor elements 3, 4 accommodated in the receiving grooves. As already described above, the second support elements 22 at their sides respectively facing the laminated core 2 form the second stop faces 23 aligned in a vertical direction.

Following the radial advance of the second support elements 22, their second stop faces 23 are readjusted toward the direction of the laminated core in an axial direction with respect to the longitudinal axis 6 to such an extent that the second stop faces 23 come into flush contact with the second front face 8 of the laminated core 2. This already allows to achieve a low, sufficient clamping effect of the laminated core 2 between the support elements 20, 22. Finally the second support elements 22 are readjusted further toward a direction of the longitudinal axis 6, wherein the second support elements 22 are also preferably readjusted into each open space located in a circumferential direction between the conductor elements 3, 4.

The readjusting of the first support elements 20 and/or of the second support elements 22 into the open spaces respectively located in a circumferential direction between the conductor elements 3, 4 can be done to such an extent that the open spaces between individual conductor elements 3, 4 are fully or at least almost fully filled out by the support elements 20 and/or 22. This already allows to achieve a certain clamping of the conductor elements 3, 4 by the support elements 20, 22.

After the first front face 7 of the laminated core 2 has come into flush contact with and is supported by the first stop faces 21 of the first support elements 20, and with a position of the first support elements 20 respectively located in the open spaces between the conductor elements 3, 4 in a circumferential direction, the laminated core 2 including the conductor elements 3, 4 can be held clamped by the first support elements 20 and/or at the first retaining projections 28. Preferably, the holding and clamping of the laminated core 2 is done by means of the first retaining projections 28, which are arranged or configured at the first support elements 20 or at the first slider elements 26. The same is also true for the second holding unit 18 with its second support elements 22 as well as the second retaining projections 29 arranged or configured at same if required. In this way, even after the second stop faces 23 of the second support elements 22 have come into flush axial contact with and are supported by the second front face 8 of the laminated core 2, and with a position of the second support elements 22 respectively located in the open spaces between the conductor elements 3, 4 in a circumferential direction, the laminated core 2 including the conductor elements 3, 4 can be held clamped by the second support elements 22 and/or the second retaining projections 29 arranged or configured at same.

The inserting of the laminated core 2 including the conductor elements 3, 4 in the device 16 can be done by means of the holding device 34 as well as the holding elements 36 arranged circumferentially spread at the holding arm 35. When the laminated core 2 is held clamped by the first support elements 20 as well as, if required, the first retaining projections 28 and also the second stop faces 23 of the second support elements 22 are in flush contact with the second front face 8 of the laminated core 2, the holding elements 36 pushed against the inner surface of the laminated core 2 can be readjusted away from the inner surface and the holding arm 35 of the holding device 34 can be readjusted out of the interior of the laminated core 2 in an axial direction. When the holding device 34 with the holding elements 36 is unstressed and readjusted out, the further radial readjustment movements of the second support elements 22 into the open spaces respectively located between the conductor elements 3, 4 can be done. If also the second retaining projections 29 are provided, these can also come into flush contact with the outer circumference of the laminated core 2 and the clamping of the laminated core 2 associated therewith.

FIG. 4 shows the situation in which the laminated core 2 including the conductor elements 3, 4 has been brought into flush contact with the first stop faces 21 of the first support elements 20. The second ends 25 of the second support elements 22 are as yet arranged at a distance in a radial direction from the outer circumference of the laminated core 2.

FIG. 5 shows that the first support elements 20 have been readjusted into the open spaces between the conductor elements 3, 4 and also the first retaining projections 28 have come into flush contact with the laminated core 2 and therefore been readjusted to a clamping hold at the laminated core 2 in a direction toward the longitudinal axis 6. The second support elements 22 have been readjusted to the first intermediate position in a radial direction toward the longitudinal axis 6, wherein these, however, are located just outside of the second layer 10 of the conductor elements 4, which are the outer conductor elements here.

FIG. 6 shows the readjustment having been done in an axial direction of the second support elements 22 in a direction toward the first support elements 20 of the first holding unit 17, so that their second stop faces 23 come into flush contact with the second front face 8 of the laminated core 2.

FIG. 7 then shows in a schematic manner that, for one thing, the holding device 34 has been readjusted out of the interior of the laminated core 2 and also the second support elements 22 have been readjusted into the open spaces located between the conductor elements 3, 4. It should be noted in this context that the holding device 34 is preferably readjusted out of the laminated core 2 first before the second support elements 22 are readjusted into the open spaces between the conductor elements 3, 4. However, it would also be possible to first readjust the second support elements 22 into the open spaces between the conductor elements 3, 4 and, if required, hold clamped the laminated core 2 with the second retaining projections 29 arranged at same before the laminated core 2 is released by the holding device 34 and the latter is readjusted out of the laminated core 2.

In the operating state of the device 16 depicted in FIG. 7, the rigid radial clamping of the laminated core 2 is done both by the first holding unit 17 with the first support elements 20 as well as, if required, the first retaining projections 28 and the second holding unit 18 with its second support elements 22 as well as, if required, the second retaining projections 29. Rigid clamping is understood to mean that a high clamping force is exerted on the laminated core 2.

Finally FIG. 8 shows that in addition to the radial clamping and holding of the laminated core 2 by the support elements 20, 22 as well as, if required, also the retaining projections 28, 29 the laminated core 2 is pushed by the second holding unit 18, in particular the second support elements 22, in an axial direction against the first holding unit 17 with the first support elements 20 arranged there and is therefore rigidly clamped also in this direction.

In contrast to this, it would, however, also be possible to readjust the second support elements 22 to the first intermediate position in a radial direction toward the longitudinal axis 6 after the first front face 7 of the laminated core 2 has come into flush contact with the first stop faces 21 of the first support elements 20—see FIG. 4 below—, so that the second ends 25 of the second support elements 22 are located just outside of the conductor elements 3, 4 accommodated in the receiving grooves 5—see FIG. 5 above. Subsequently, the second support elements 22 are then advanced in a direction toward the first support elements 20 of the first holding unit 17, so that their second stop faces 23 come into flush contact with the second front face 8 of the laminated core 2—see FIG. 6 above.

When the majority of both the first and second stop faces 21, 23 are in flush contact with the respective front faces 7, 8 of the laminated core 2, the support elements 20, 22 are readjusted respectively into the open spaces located between the conductor elements 3, 4. This can be done simultaneously (at the same time) or at different times. If the flush contact of the support elements 20, 22 with the laminated core 2 were too far axial, this would result in strong readjustment forces of the support elements 20, 22 due to the friction. This should be avoided.

The clamping of the laminated core 2 at its outer circumference by means of the retaining projections 28, 29 can then be done additionally and optionally but is not necessarily mandatorily required.

As the finger-like support elements 20, 22 preferably arranged respectively in pairs can also build up a spring effect viewed in a circumferential direction, this already allows to achieve a clamping of at least individual of the conductor elements 3, 4 by the support elements 20, 22 as soon as these have been readjusted far enough between these.

As even low variations in sheet thickness of the sheet metal segments forming the laminated core may cause different final sizes, it becomes possible in this rigidly-clamped position to acquire the distance or the space between the first stop faces 21 and the second stop faces 23. In this at least in an axial direction rigidly-clamped position of the laminated core 2 a clamping force or pressure is applied or built up which corresponds more or less to the net weight or the net mass of the laminated core 2. For example, the net weight or the net mass in smaller sizes may have a value between 10 N and 300 N, in larger construction types even up to 2500 N and beyond. The measuring of the overall thickness is carried out only once at least this pressure is acting on the laminated core 2.

This can be done, for example, —as preferably the first holding unit 17 with its first support elements 20 forms the reference plane or plane of reference at the first stop faces 21—by the relative position of the second holding unit 18 with respect to the first holding unit 17 being able to be established by means of adequate measuring means and the actual distance and/or the space between the second stop faces 23 arranged spaced apart from the first stop faces 21 being able to be acquired via this specification of position. However, also other known measuring procedures or measuring means can be used to be able to acquire the distance and/or the space between the first stop faces 21 and the second stop faces 23.

Once also the axial clamping of the laminated core 2 has been done, the laminated core 2 held clamped by the first and second support elements 20, 22 as well as, if required, the first and second retaining projections 28, 29 and aligned in a positioned manner can be transported at least including the support elements 20, 22 to a downstream deforming station for deforming the end portions 11, 12 protruding respectively beyond the two front faces 7, 8 and/or 13, 14 of the conductor elements 3, 4, wherein the deforming station is not depicted in more detail.

The exemplary embodiments show possible embodiment variants, and it should be noted in this respect that the invention is not restricted to these particular depicted embodiment variants of it, but that rather various combinations of the individual embodiment variants with each other are possible and this possibility of variants based on the technical teaching by means of the invention at issue lies within the ability of the person skilled in the art in this technical field.

The scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

Any and all specifications of value ranges in the present description are to be understood to comprise any and all sub-ranges of same, for example the specification 1 to 10 is to be understood to mean that any and all sub-ranges starting from the lower limit 1 and from the upper limit 10 are comprised therein, i.e. any and all sub-ranges start at a lower limit of 1 or larger and end at an upper limit of 10 or less, e.g. 1 to 1.7, or 3.2 to 8.1, or 5.5 to 10.

Finally, as a matter of form, it should be noted that for ease of understanding of the structure, elements are partially not depicted to scale and/or are enlarged and/or are reduced in size.

List of Reference Numbers

| | |
|---|---|
| 1 | stator |
| 2 | laminated core |
| 3 | conductor element |
| 4 | conductor element |
| 5 | receiving groove |
| 6 | longitudinal axis |
| 7 | first front face |
| 8 | second front face |
| 9 | first layer |
| 10 | second layer |
| 11 | first end portion |
| 12 | first end portion |
| 13 | second end portion |
| 14 | second end portion |
| 15 | insulation element |
| 16 | device |
| 17 | first holding unit |
| 18 | second holding unit |
| 19 | base frame |
| 20 | first support element |
| 21 | first stop face |
| 22 | second support element |
| 23 | second stop face |
| 24 | first end |
| 25 | second end |
| 26 | first slider element |
| 27 | second slider element |
| 28 | first retaining projection |
| 29 | second retaining projection |
| 30 | first drive device |
| 31 | second drive device |
| 32 | pressure element |
| 33 | pressure device |
| 34 | holding device |
| 35 | holding arm |
| 36 | holding element |
| 37 | third drive device |

1. A method for the positioned holding of a laminated core including at least one layer accommodated in the laminated core, which layer is made up of several conductor elements arranged spread over the circumference of the laminated core and configured as rods for forming a stator or a rotor of an electric machine, comprising the following steps:
provisioning of the laminated core made up of several sheet metal segments resting directly against each other and defining a longitudinal axis, wherein several receiving grooves arranged spread over the circumference are arranged in the laminated core and the receiving grooves extend respectively between a first front face and a second front face, wherein the receiving grooves serve to accommodate circuit sections of an electric winding,
provisioning of the rod-shaped conductor elements, respectively having a first end portion and respectively having a second end portion spaced apart therefrom, wherein the conductor elements serve to form the electric winding and the conductor elements are configured with a rod length which is larger than a thickness of the laminated core between its first front face and its second front face,
inserting of at least one of the conductor elements in several of the receiving grooves, and
positioned aligning of the conductor elements in an axial direction with respect to at least one of the two front faces of the laminated core, wherein the first end portions of the conductor elements protrude respectively beyond the first front face and the second end portions protrude respectively beyond the second front face, wherein
a plurality of first support elements arranged spread over the circumference and configured in a rod shape with its first ends facing the longitudinal axis are readjusted from a position not overlapping an outer circumference of the laminated core in a direction toward the longitudinal axis to a position overlapping section by section the first front face in a direction toward the longitudinal axis to such an extent that the first ends are located on the side facing away from the longitudinal axis as well as just outside of the conductor elements accommodated in the receiving grooves and the first support elements at their sides respectively facing toward the laminated core form a first stop face aligned in a vertical direction,
the laminated core including the conductor elements aligned in a positioned manner with the longitudinal axis having a horizontal alignment comes with its first front face into flush contact in an axial direction with the first stop faces of the first support elements,
a plurality of second support elements arranged spread over the circumference and configured in a rod shape with their second ends facing the longitudinal axis are readjusted from a position not overlapping an outer circumference of the laminated core in a direction toward the longitudinal axis to a position overlapping section by section the second front face in a direction toward the longitudinal axis to such an extent that the second ends are located on the side facing away from the longitudinal axis as well as just outside of the conductor elements accommodated in the receiving grooves and the second support elements at their sides respectively facing the laminated core form a second stop face aligned in a vertical direction,
the second support elements with their second stop faces in an axial direction with respect to the longitudinal axis are readjusted in a direction toward the laminated core until a majority of the second stop faces are in flush contact with the second front face,
the first support elements are readjusted further in a direction toward the longitudinal axis, wherein preferably at least one of the first support elements is readjusted into each open space located between the conductor elements in a circumferential direction, and
the second support elements are also readjusted further in a direction toward the longitudinal axis, wherein preferably at least one of the second support elements is readjusted into each open space located between the conductor elements in a circumferential direction.

2. The method according to claim 1, wherein the first support elements or the second support elements, or both are readjusted into the open spaces respectively located between the conductor elements in a circumferential direction to such an extent that the open spaces between the individual conductor elements are fully or at least almost fully filled out.

3. The method according to claim 1, wherein the readjustment of the first support elements and of the second support elements is carried out respectively in a radial direction.

4. The method according to claim 1, wherein the laminated core including the conductor elements aligned in a positioned manner is accommodated by a holding arm of a holding device before its first front face comes into flush contact with the first stop faces of the first support elements, wherein holding elements located at the holding arm and readjustable in a radial direction are pushed against an inner surface of the laminated core.

5. The method according to claim 1, wherein the respective end portions of the conductor elements of the at least one layer, which end portions are aligned in a positioned manner and protrude beyond the laminated core, are subjected by at least one pressure element of a pressure device to a pressure built up by the at least one pressure element readjustable at least in a radial direction and are thus held in a direction of the longitudinal extent of the receiving grooves positioned with respect to the laminated core.

6. The method according to claim 1, wherein the laminated core including the conductor elements aligned in a positioned manner is aligned in a positioned manner in a circumferential direction with respect to a target position before its first front face comes into flush contact with the first stop faces of the first support elements.

7. The method according to claim 1, wherein the laminated core including the conductor elements aligned in a positioned manner is pivoted from a position of the longitudinal axis having a vertical alignment to the position of the longitudinal axis having a horizontal alignment before its first front face comes into flush contact with the first stop faces of the first support elements.

8. The method according to claim 1, wherein the first support elements are arranged or configured respectively at least in pairs at a first slider element and the second support elements are arranged or configured respectively at least in respective pairs at a second slider element.

9. The method according to claim 1, wherein a first retaining projection is arranged or configured respectively at the first support elements, in particular at the first slider elements, and a second retaining projection is arranged or configured respectively at the second support elements, in particular at the second slider elements.

10. The method according to claim 1, wherein after the first front face of the laminated core has come into flush contact with and is supported by the first stop faces of the first support elements, and with the first support elements being in the position in a circumferential direction in the open spaces respectively located between the conductor elements, the laminated core including the conductor elements is held clamped by the first support elements or the first retaining projections, or both.

11. The method according to claim 1, wherein after the second stop faces of the second support elements have come into axial flush contact with and are supported by the second front face of the laminated core and before the further radial readjustment movement of the second support elements into the open spaces respectively located between the conductor elements or after this readjustment movement, the holding elements pushed against the inner surface of the laminated core are readjusted away from the inner surface and the holding arm of the holding device is readjusted in an axial direction out of the interior of the laminated core.

12. The method according to claim 9, wherein after the second stop faces of the second support elements have come into flush contact with and are supported by the second front face of the laminated core, and with the second support elements being in the position in a circumferential direction in the open spaces respectively located between the conductor elements, the laminated core including the conductor elements is held clamped by the second support elements or the second retaining projections, or both.

13. The method according to claim 1, wherein the first support elements, in particular the first slider elements, are readjusted in a radial direction by a first drive device, in particular a cylinder-piston configuration, a servo drive, and the second support elements, in particular the second slider elements, are readjusted also in a radial direction by a second drive device, in particular a cylinder-piston configuration, a servo drive.

14. The method according to claim 1, wherein the first support elements, in particular the first slider elements, are arranged positioned in place in an axial direction and the first stop faces form a reference plane having a vertical alignment.

15. The method according to claim 1, wherein at least the second support elements, in particular at least the second slider elements, are readjustable in an axial direction with respect to the first support elements, in particular with respect to the first slider elements.

16. The method according to claim 1, wherein at least the second support elements, in particular the second slider elements, are readjusted together in an axial direction by a third drive device, in particular a cylinder-piston configuration, a servo drive.

17. The method according to claim 1, wherein the laminated core located in an axial direction between the first support elements and the second support elements is pushed against the first support elements by the second support elements in an axial direction.

18. The method according to claim 1, wherein an axial distance in a normal direction between the first and second stop faces is acquired with the laminated core located between the first support elements and the second support elements and with the first stop faces in flush contact with the first front face and the second stop face in flush contact with the second front face of the laminated core.

19. The method according to claim 1, wherein the laminated core aligned in a positioned manner by the first and second support elements is transported at least including the support elements to a downstream deforming station for deforming the end portions of the conductor elements protruding respectively beyond the two front faces.

20. A device for the positioned holding of a laminated core including at least one layer accommodated in the laminated core, which layer is made up of several conductor elements arranged spread over the circumference of the laminated core and configured as rods for forming a stator or a rotor of an electric machine and for carrying out the method of claim 1, wherein the device comprises:
a first holding unit with a plurality of first support elements arranged spread over the circumference and configured in a rod shape, wherein a first stop face aligned in a vertical direction is formed by the first support elements at their sides which are respectively turnable toward the laminated core and the first support elements are readjustably guided in a radial direction at the first holding unit,
a second holding unit with a plurality of second support elements arranged spread over the circumference and configured in a rod shape, wherein a second stop face aligned in a vertical direction is formed by the second support elements at their sides which are respectively turnable toward the laminated core and the second support elements are readjustably guided in a radial direction at the second holding unit, and
at least one of the two holding units is readjustably guided at a base frame in a normal direction with respect to the stop faces with respect to the other holding unit.

21. The device according to claim 20, wherein the first support elements are arranged or configured respectively at least in pairs at a first slider element and the second support elements are arranged or configured respectively at least in pairs at a second slider element and the first slider elements are guided at the first holding unit and the second slider elements are guided at the second holding unit.

22. The device according to claim 20, wherein a first retaining projection is arranged or configured respectively at the first support elements, in particular at the first slider elements, and a second retaining projection is arranged or configured respectively at the second support elements, in particular at the second slider elements, and the first retaining projections and the second retaining projections are arranged at sides of the support elements, in particular of the slider elements, respectively facing each other.

23. The device according to claim 20, wherein the first support elements, in particular the first slider elements, are in drive connection with a first drive device, in particular a cylinder-piston configuration, a servo drive, and the second support elements, in particular the second slider elements, are in drive connection with a second drive device, in particular a cylinder-piston configuration, a servo drive, and the drive devices can carry out the readjustment movements in a radial direction.

24. The device according to claim 20, wherein the first holding unit is arranged positioned in place at the base frame and the first stop faces of the first support elements form a reference plane with a vertical alignment.

25. The device according to claim 20, wherein at least the second holding unit is readjustably guided at the base frame in an axial direction with respect to the first holding unit and the second holding unit is in drive connection with a third drive device, in particular a cylinder-piston configuration, a servo drive.
